(19) United States
(12) Patent Application Publication
(10) Pub. No.: US 2025/0381931 A1
(43) Pub. Date: Dec. 18, 2025

(54) SEATBACK

(71) Applicant: TOYOTA BOSHOKU KABUSHIKI KAISHA, Aichi (JP)

(72) Inventor: Keisuke YAMAMOTO, Toyota-shi (JP)

(73) Assignee: TOYOTA BOSHOKU KABUSHIKI KAISHA, Aichi (JP)

(21) Appl. No.: 19/228,061

(22) Filed: Jun. 4, 2025

(30) Foreign Application Priority Data
Jun. 12, 2024 (JP) 2024-095144

(51) Int. Cl. B60R 22/26; B60N 2/64; B60R 22/18; B60R 22/34

(52) U.S. Cl. CPC B60R 22/26; B60N 2/64; B60R 2022/1818; B60R 22/34

(57) ABSTRACT

A seatback to be applied to a vehicle seat includes an upper frame that forms a part of a back frame and that extends in seat width directions at an upper end side of the back frame, and a bezel having a flat tubular shape that is inserted and installed within a through hole passing through the upper frame in up-down directions and that allows a belt portion of a seat belt to be inserted therethrough.

### CROSS-REFERENCE TO RELATED APPLICATIONS

This application claims the benefit of Japanese Patent Application No. 2024-095144 filed on Jun. 12, 2024 with the Japan Patent Office, and the entire disclosure of Japanese Patent Application No. 2024-095144 is incorporated herein by reference.

### BACKGROUND

The present disclosure relates to a seatback to be applied to a vehicle seat. For example, in a vehicle seat described in Japanese Unexamined Patent Application Publication No. 2021-87648, an opening through which a belt portion (also referred to as a “webbing”) of a seat belt enters and exits is provided in a portion of a seat back corresponding to a shoulder tip. In this seatback, a gate-shaped metal wire is welded to a pipe-shaped upper frame. This metal wire is a member for receiving a forward force (hereinafter simply referred to as a “tension”) acting on the seatback due to a tension generated in the belt portion.

### SUMMARY

The present disclosure discloses an example of a seatback in which the tension can be received with a novel configuration different from that of the invention described in Japanese Unexamined Patent Application Publication No. 2021-87648.

It is desirable that a seatback to be applied to a vehicle seat comprise, for example, at least one of the following elements.

Specifically, the elements are: an upper frame forming a part of a back frame, the upper frame extending in seat width directions at an upper end side of the back frame; and a bezel having a flat tubular shape inserted and installed within a through hole passing through the upper frame in up-down directions, the bezel allowing a belt portion of a seat belt to be inserted therethrough.

This allows the seatback to dispense with a gate-shaped metal wire and to be configured such that a tension generated in the belt portion is directly received by the upper frame. Accordingly, it is not necessary to weld the metal wire to the upper frame and thus, for example, adherence of welding spatters to the upper frame does not occur. This can inhibit damages to the belt portion caused by such welding spatters.

Moreover, in a conventional configuration in which the belt portion is in direct contact with the metal wire, rust-preventing treatment, such as cationic coating, is applied to the welded metal wire. However, since this seatback is configured such that the belt portion is inserted through the bezel, the rust-preventing treatment, such as cationic coating, is dispensable.

This seatback may be configured as follows, for example. Specifically, it is desirable that a cross-sectional shape of the upper frame projected onto an imaginary plane perpendicular to the seat width directions be a substantially C shape or substantially U shape with corners, which is opened on a seat rear side. It is desirable that this seatback further comprise: a front wall provided at least on a seat front side of an outer circumference of the through hole opened in a topside of the upper frame, the front wall including a face substantially parallel to an inserting direction of the bezel; and a rear wall provided at least on a seat rear side of an outer circumference of the through hole opened in an underside of the upper frame, the rear wall including a face substantially parallel to the inserting direction of the bezel.

This allows the seatback to have a configuration in which portions where a contact surface pressure is highly likely to increase are provided with the front and rear walls that increase a contact area, and thus, excessive increase in the contact surface pressure can be inhibited. This can eventually inhibit the bezel and the belt portion from being damaged earlier.

It is desirable that this seatback further comprise a reinforcing plate provided onto a portion, of a front face of the upper frame, corresponding to a portion where at least the through hole is arranged, the reinforcing plate being joined onto the front face. In addition, it is desirable that the reinforcing plate be provided with a fixing portion where a retractor of the seat belt is fixed. The front wall may be provided to the reinforcing plate.

### BRIEF DESCRIPTION OF THE DRAWINGS

Example embodiments of the present disclosure will be described below with reference to the accompanying drawings, in which:

FIG. 1 is a diagram showing a seatback according to a first embodiment;

FIG. 2 is a side view of an upper frame according to the first embodiment;

FIG. 3 is an exploded view of the upper frame according to the first embodiment;

FIG. 4 is a diagram showing a structure of the upper frame according to the first embodiment;

FIG. 5 is a diagram showing a structure of the upper frame according to the first embodiment; and

FIG. 6 is a diagram showing a structure of an upper frame according to a second embodiment.

### DETAILED DESCRIPTION OF EXEMPLARY EMBODIMENTS

Embodiments below show examples of embodiments that fall within the technical scope of the present disclosure. That is, invention-specifying matters and so on recited in the appended claims are not limited by specific configurations, structures, and so on indicated in the embodiments below.

The embodiments below are examples in which a seatback according to the present disclosure is applied to a seat to be mounted in a vehicle such as an automobile (hereinafter referred to as a “vehicle seat”). Arrows indicating directions, hatched lines, and so on shown in the drawings are provided for the purpose of easier understanding of mutual relationships between the drawings, shapes of members or portions, and so on.

Thus, the seatback is not limited by the directions shown in the drawings.

The directions shown in the drawings are directions in a state where the vehicle seat according to the embodiments below is mounted in the automobile. The drawings provided with hatched lines do not always represent sectional views.

A member or a portion described at least with a reference numeral is at least one in number except in a case of being accompanied by a restrictive wording such as “only one”. In other words, the member or the portion may be two or more in number in a case of not being accompanied by the restrictive wording such as “only one”. The seatback indicated in the present disclosure comprises at least one of (i) an element such as the member or the portion described at least with a reference numeral or (ii) a structural portion shown in the drawings.

### First Embodiment

### <1. Overview of Seatback>

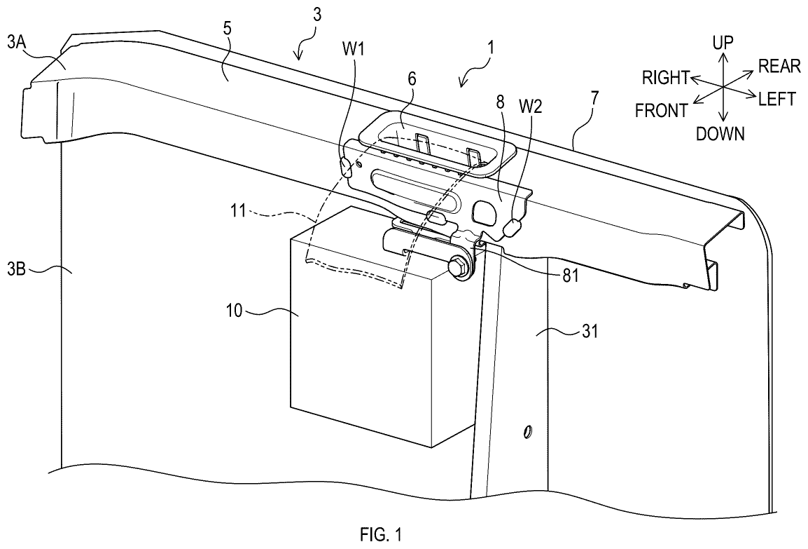

A seatback 1 shown in FIG. 1 is a seatback for a rear seat of a vehicle. The seatback 1 is mounted in the vehicle and supports a back of an occupant. The seatback 1 comprises at least a back frame 3, a back cushion (not shown), and so on.

The back frame 3 is a high-strength member forming a skeleton of the seatback 1. The back cushion is a cushion member arranged on a front side of the back frame 3. A surface of the back cushion is covered by a covering (not shown) or the like.

The back frame 3 comprises a rail frame 3A, a panel frame 3B, and so on. The rail frame 3A forms the skeleton having a rectangular-frame-like shape. The rail frame 3A comprises an upper frame 5 and so on. The upper frame 5, which is a member forming a part of the back frame 3, is a high-strength member extending in seat width directions at an upper end side of the back frame 3.

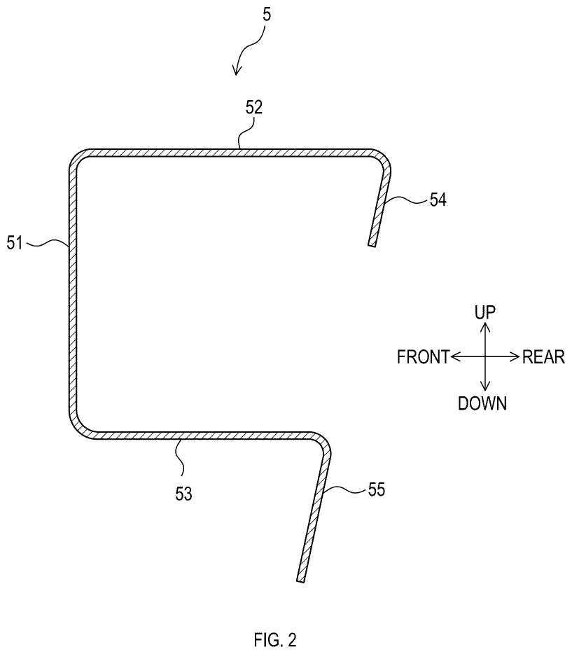

The upper frame 5 is formed such that a cross-sectional shape thereof projected onto an imaginary plane perpendicular to the seat width directions is a substantially C shape or substantially U shape with corners, which is opened on a seat rear side. Specifically, as shown in FIG. 2, the upper frame 5 comprises a first wall 51, a second wall 52, a third wall 53, a first flange 54, a second flange 55, and so on.

The first wall 51 comprises a face substantially perpendicular to seat front-rear directions. The second wall 52 extends rearward from an upper end of the first wall 51. The third wall 53 extends rearward from a lower end of the first wall 51.

The first flange 54 extends downward from a rear end of the second wall 52. The second flange 55 extends downward from a rear end of the third wall 53. As shown in FIG. 1, joined to the upper frame 5 at a rear side thereof is a back panel 7.

The back panel 7 is a plate-like member constituting the panel frame 3B. The back panel 7 is joined by welding or other means at a rear side of the back frame 3 so as to close an opening located on the rear side of the upper frame 5.

The back frame 3 comprises at least a side frame 31 and so on in addition to the upper frame 5. The side frame 31 extends in up-down directions, and an upper end part thereof is joined to the upper frame 5.

The upper frame 5 and the back panel 7 are made of a rolled steel plate, such as SPHC. The upper frame 5 is a one-piece article obtained by applying plastic working to the rolled steel plate to integrally form the first wall 51, the second wall 52, the third wall 53, the first flange 54, and the second flange 55.

As shown in FIG. 1, the seatback 1 of the present embodiment is provided with a retractor 10 for a seat belt. The retractor 10 is a device configured to retract a belt portion (also referred to as a “webbing”) 11 of the seat belt.

### <2. Details of Upper Frame>

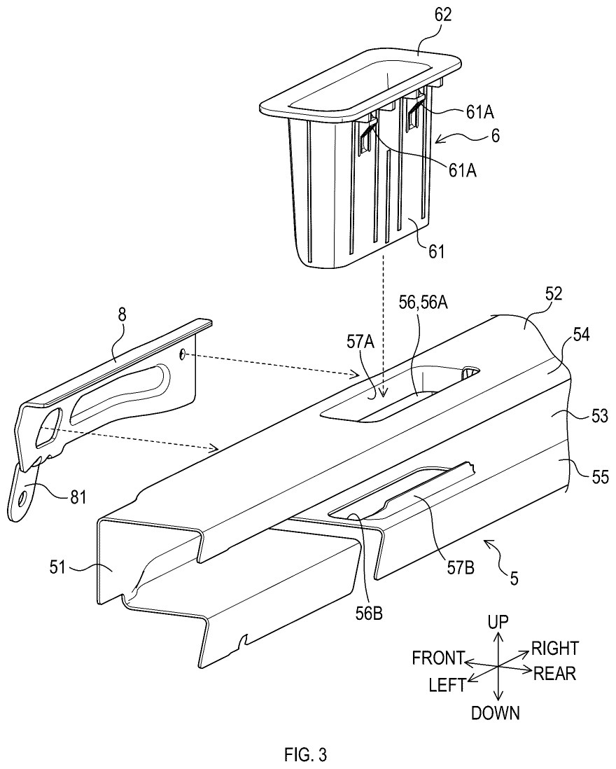

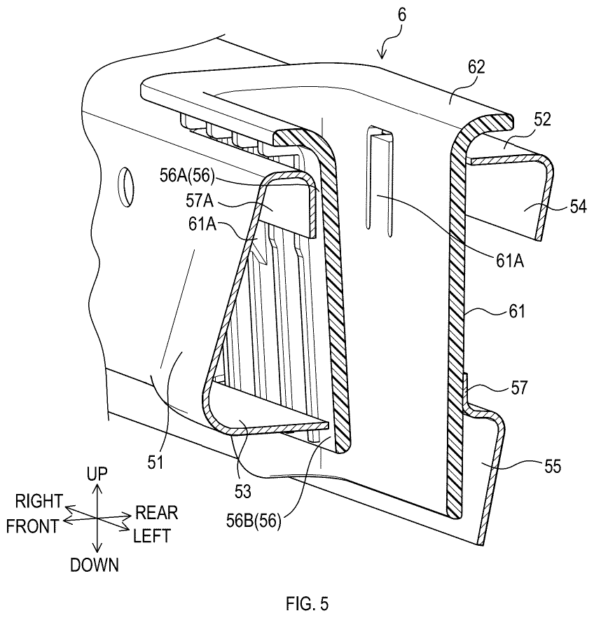

As shown in FIGS. 3 to 5, the upper frame 5 is provided with a bezel 6 and a reinforcing patch 8. The bezel 6 is a flat tubular resin member through which the belt portion 11 is inserted. The bezel 6 is inserted and installed within a through hole 56 (see FIG. 3) passing through the upper frame 5 in the up-down directions.

Specifically, the second wall 52 contains a through hole 56A opened in the up-down directions. The third wall 53 contains a through hole 56B opened in the up-down directions. The bezel 6 comprises a tubular portion 61 having a flat tubular shape, a flange portion 62 having a brim-like shape, and so on.

The tubular portion 61 is inserted within the through holes 56A and 56B. The flange portion 62 is a flared portion provided to an upper end of the tubular portion 61. The tubular portion 61 is provided with at least one lock portion 61A (two or more lock portions 61A, in the present embodiment).

Each lock portion 61A is a snap-fit portion to be caught and locked on an underside of the second wall 52. The flange portion 62 and the two or more lock portions 61A form a one-piece article integrally formed of resin together with the tubular portion 61.

A front wall 57A is provided at least on a seat front side of an outer circumference of the through hole 56A opened in a topside of the upper frame 5. The front wall 57A comprises a face that extends from this outer circumference and that is substantially parallel to an inserting direction of the bezel 6.

A rear wall 57B is provided at least on the seat rear side of an outer circumference of the through hole 56B opened in an underside of the upper frame 5. The rear wall 57B comprises a face that extends from this outer circumference and that is substantially parallel to the inserting direction of the bezel 6.

The inserting direction substantially coincides with an extending direction of the tubular portion 61 of the bezel 6. The front wall 57A and the rear wall 57B of the present embodiment are integrally formed by burring in the upper frame 5.

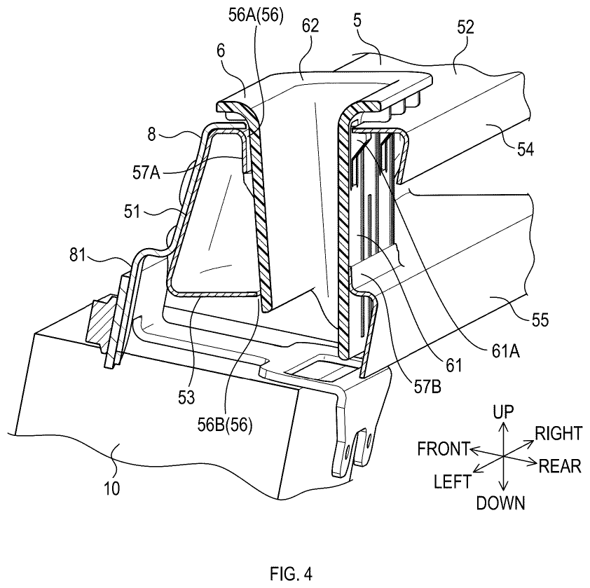

As shown in FIG. 4, the reinforcing patch 8 is an example of a reinforcing plate provided onto a portion, of a front face of the upper frame 5, corresponding to a portion where at least the through hole 56 is arranged. The reinforcing patch 8 is joined onto this front face by welding or other means.

As shown in FIG. 1, the reinforcing patch 8 is welded onto the upper frame 5 at least at one end side and the other end side, in the seat width directions, of the reinforcing patch 8 (see W1 and W2 in FIG. 1). The reinforcing patch 8 is provided with a fixing portion 81. The fixing portion 81 is a portion where an upper end portion of the retractor 10 is fixed.

### 3. Characteristics of Seatback of Present Embodiment

In the seatback 1 of the present embodiment, the bezel 6 is inserted and installed within the through hole 56 passing through the upper frame 5 in the up-down directions. This allows the seatback 1 to dispense with a conventional gate-shaped metal wire and to be configured such that a tension generated in the belt portion 11 is directly received by the upper frame 5.

Accordingly, it is not necessary to weld the metal wire to the upper frame 5 and thus, for example, adherence of welding spatters to the upper frame 5 does not occur. This can eventually inhibit damages to the belt portion 11 caused by such welding spatters.

Moreover, in a conventional configuration in which the belt portion 11 is in direct contact with the metal wire, rust-preventing treatment, such as cationic coating, is applied to the welded metal wire. However, since the seatback 1 of the present disclosure is configured such that the belt portion 11 is inserted through the bezel 6, the rust-preventing treatment, such as cationic coating, is dispensable.

In the meantime, when a large tension is generated in the belt portion 11, a contact surface pressure is highly likely to increase on the seat front side of the outer circumference of the through hole 56A opened in the topside of the upper frame 5 and on the seat rear side of the outer circumference of the through hole 56B opened in the underside of the upper frame 5.

To cope with this, in the seatback 1, the front wall 57A is provided on the seat front side of the outer circumference of the through hole 56A opened in the topside of the upper frame 5, and the rear wall 57B is provided on the seat rear side of the outer circumference of the through hole 56B opened in the underside of the upper frame 5.

Specifically, in the seatback 1, portions where a contact surface pressure is highly likely to increase are provided with the walls 57A and 57B that increase a contact area, and thus, excessive increase in the contact surface pressure can be inhibited. This can eventually inhibit the bezel 6 and the belt portion 11 from being damaged earlier.

The reinforcing patch 8 is provided onto the portion, of the front face of the upper frame 5, corresponding to the portion where at least the through hole 56 is arranged. Thus, even when a large tension is generated in the belt portion 11 to cause a large load to act on the upper frame 5, the upper frame 5 can bear such a load.

### Second Embodiment

In the above-described embodiment, the front wall 57A is provided, as a portion integral with the upper frame 5, on the outer circumference on the seat front side of the through hole 56A.

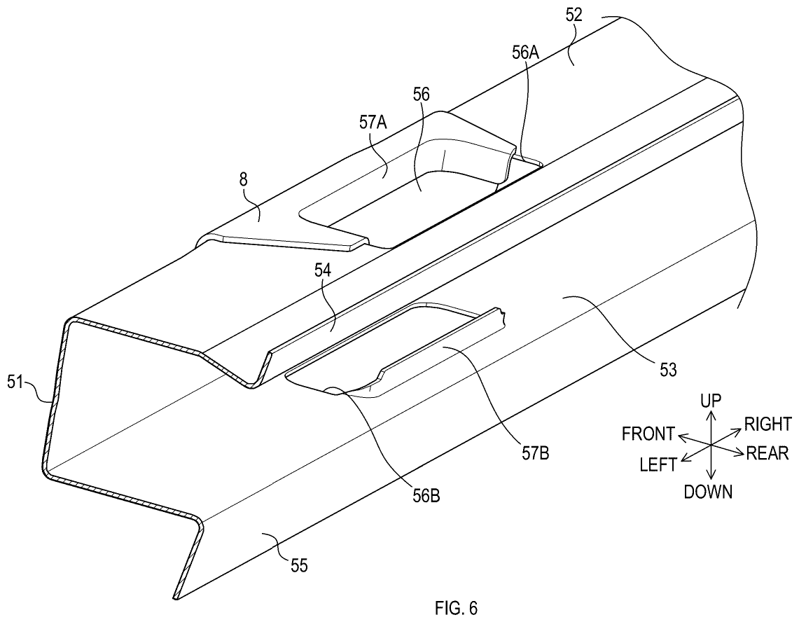

In contrast, as shown in FIG. 6, the second embodiment is configured such that the front wall 57A is provided, as a portion integral with the reinforcing patch 8, on the outer circumference on the seat front side of the through hole 56A. It is to be noted that the first flange 54 of the present embodiment extends upward from the rear end of the second wall 52.

### OTHER EMBODIMENTS

The rear wall 57B of the above-described embodiments extends upward. However, the present disclosure is not limited thereto. Specifically, in the present disclosure, the rear wall 57B may extend downward, for example.

The upper frame 5 of the above-described embodiments has a cross-section of a substantially C shape or substantially U shape with corners, which is opened on the seat rear side. However, the present disclosure is not limited thereto. Specifically, in the present disclosure, the upper frame 5 having a rectangular closed cross-sectional shape, a circular closed cross-sectional shape, or the like may be employed, for example.

The upper frame 5 of the above-described embodiments comprises the reinforcing patch 8. However, the present disclosure is not limited thereto. Specifically, in the present disclosure, the reinforcing patch 8 may be omitted, for example.

The upper frame 5 of the above-described embodiments comprises the first flange 54 and the second flange 55. However, the present disclosure is not limited thereto. Specifically, in the present disclosure, the first flange 54 and the second flange 55 may be omitted, for example.

In the above-described embodiments, the front wall 57A and the rear wall 57B are provided. However, the present disclosure is not limited thereto. Specifically, in the present disclosure, at least one of the front wall 57A or the rear wall 57B may be omitted, for example.

In the above-described embodiments, the vehicle seat according to the present disclosure is applied to an automobile. However, application of the disclosure disclosed herein is not limited thereto. Specifically, the present disclosure is also appliable to, for example, a seat used in vehicles, such as railroad vehicles, ships, or aircraft, and to a stationary seat used in theaters, at home, or in other places.

Moreover, it is sufficient that the present disclosure be consistent with the gist of the disclosure described in the above-described embodiments, and the present disclosure is not limited by the above-described embodiments. Therefore, a configuration may be employed in which at least two embodiments among the above-described embodiments are combined together or in which any of the elements shown in the drawings or the elements described with reference numerals is omitted in the above-described embodiments.

What is claimed is:

1. A seatback to be applied to a vehicle seat, the seatback comprising:
an upper frame forming a part of a back frame, the upper frame extending in seat width directions at an upper end side of the back frame; and
a bezel having a flat tubular shape inserted and installed within a through hole passing through the upper frame in up-down directions, the bezel allowing a belt portion of a seat belt to be inserted therethrough.

2. The seatback according to claim 1,
wherein a cross-sectional shape of the upper frame projected onto an imaginary plane perpendicular to the seat width directions is a substantially C shape or substantially U shape with corners, which is opened on a seat rear side.

3. The seatback according to claim 2, further comprising:
a front wall provided at least on a seat front side of an outer circumference of the through hole opened in a topside of the upper frame, the front wall including a face substantially parallel to an inserting direction of the bezel; and
a rear wall provided at least on a seat rear side of an outer circumference of the through hole opened in an underside of the upper frame, the rear wall including a face substantially parallel to the inserting direction of the bezel.

4. The seatback according to claim 3, further comprising:
a reinforcing plate provided onto a portion, of a front face of the upper frame, corresponding to a portion where at least the through hole is arranged, the reinforcing plate being joined onto the front face.

5. The seatback according to claim 4,
wherein the reinforcing plate is provided with a fixing portion where a retractor of the seat belt is fixed.

6. The seatback according to claim 4,
wherein the front wall is provided to the reinforcing plate.
